(19) United States
(12) Patent Application Publication
(10) Pub. No.: US 2003/0189335 A1
(43) Pub. Date: Oct. 9, 2003

(54) One piece report cover

(75) Inventor: Billy D. Henderson, Crawfordsville, IN (US)

Correspondence Address: RUSSELL E. FOWLER, II, ICE MILLER, ONE AMERICAN SQUARE, BOX 82001, INDIANAPOLIS, IN, 46282-0002, US

(73) Assignee: Plastic Innovations, Inc., Indianapolis, IN

(21) Appl. No.: 10/115,853

(22) Filed: Apr. 3, 2002

(51) Int. Cl. B42D 17/00

(52) U.S. Cl. 281/43

(57) ABSTRACT

The present invention provides for an easy to manufacture, one piece design for securing and protecting a report. The one piece report cover utilizes a flat support panel upon which the report rests. A rigid angular retaining clip protrudes substantially perpendicularly from one edge of the support panel and then angles back towards the flat surface of the support panel. The angular retaining clip secures the report in place against the flat support panel. The support panel can be formed with specific dimensions to accommodate and support a report consisting of standard 8.5″ by 11″ pages, legal size pages, or A4 size pages. The single piece design of the present invention may utilize a single piece of polystyrene or any other suitable material. Additionally, some embodiments of the present invention utilize a file hanger at each end of the angular retaining clip for use of the report cover as a hanging file.

### BACKGROUND OF THE INVENTION

This invention relates generally to structures for binding and securing a plurality of sheets of paper. Specifically, the present invention relates to a single piece report cover which is capable of securing and supporting a plurality of sheets of paper.

People such as professionals, office workers, and school children utilize paper for communicative and creative endeavors on a daily basis. Such endeavors include financial statements, legal complaints, financial records, and history reports. Many of these collections of paper need to be organized, secured, and protected from damage such as warping, folding, and crumpling that can occur during transportation or storage of such collections of paper. A number of report covers and other binding solutions are known in the art for securing the individual sheets of such a collection of papers together. Hereinafter, any collection of one or more papers and any associated dividers will be referred to simply as a “report.”

One desirable feature of any binding solution is that it adequately protect the report which it contains. In both the professional world and in the academic world presentation and appearance are important. A report which is bent, folded, or crumpled is therefore undesirable. Any binding solution should incorporate structure to adequately support the pages of the report. Such adequate support must insure that the report lays relatively flat and is therefore protected from damage such as folding or crumpling. It is also desirable for any such binding solution to secure a report such that the pages of the report are unlikely to be released accidentally, but are easily removable if desired. If such pages were released accidentally, they could become damaged or misordered. At the same time, ease of page removal is desirable for editing the report, copying pages, and general accessibility of the pages.

Another desirable feature for binding solutions such as report covers is a simplified structure. The advantages of a simplified structure are at least threefold. First, while report covers are used in the professional world, they are also used by school children. Simplifying the structure of the binding solution usually increases ease of use making the binding solution more desirable for the school market. Extra components not only may make the product more difficult to use but may be misplaced if detachable from the rest of the binding solution rendering the binding solution useless. Second, a simplistic structure with few or no moving parts reduces the number of manufacturing steps and makes the binding solution easier to manufacture. Third, by allowing for fewer manufacturing steps and fewer source components, the per unit cost of manufacture may be decreased. While saving a few pennies per unit may seem inconsequential, sales in the report cover industry are high volume with a low profit margin. Any cost savings per unit has the potential to increase total profits.

One type of report cover commonly used in the art utilizes a two piece design to secure and protect the report. The report is placed in a flexible cover (often manufactured of clear plastic). Then a rigid plastic channel is slid along one edge of the flexible cover, compressing the front and rear of said cover together. This inward pressure compresses the plastic cover around one edge of the pages of the report to secure the report in place. However, this common design does not adequately address all of the desirable features previously discussed. First, while it is relatively simple in construction, its design requires the manufacture of two individual components which must be joined by the user. The necessity for two different components not only increases the relative cost of manufacture, but leads to the problem of lost components by the end user. Once again this problem is of particular importance when children are involved. Users such as children are prone to losing one of the two components leading to inoperability of the product. Second, while not difficult for some users to assemble, many users, particularly children, are prone to difficulty in sliding the rigid plastic channel along the outside of the report and therefore have difficulty using this binding solution. A third shortcoming of this common design is a tendency of the binding plastic channel to slide off the cover and become inadvertently separated from the cover. This potentially leads to damage to or misordering of the individual sheets of the report. Finally, the flexible cover of this design may not provide enough support to the pages of the report, potentially leading to unwanted bending or folding and a deterioration of the appearance of the report stored therein.

Numerous designs have been developed in attempts to improve on this simple report cover. However, such designs typically require additional components such as additional clips or fasteners. Others require fasteners which must pass through the pages of the report itself. These additional components are usually added in an attempt to provide a new feature to the report cover or improvement on binding capabilities. However, these prior art designs may also be undesirable for various reasons. Any solution which requires the use of additional clips or fasteners increases both the complexity of the manufacturing process and the expense of manufacture. Additionally, such clips or fasteners may be difficult to operate for young users. Any design which requires the insertion of components through the individual pages of the report is also undesirable because such a design requires large enough margins in the papers to allow such insertion without making portions of the content of the report illegible. Additionally, it may be undesirable to many users to permanently damage original documents in the report by punching holes in the individual sheets of the report.

Yet another desirable design feature for binding solutions such as report covers would be to provide a structure which allows the secured report to be stored as a hanging file while still incorporating the previously described desirable features. Many desks and filing cabinets employ horizontal rods to allow for the hanging of file folders having a hook or other hanging structure on each end which are then supported by the rods of the desk or filing cabinet. Such hanging file drawers allow for the convenient storage of hanging file folders and allow for the user to easily flip through the files contained therein.

The most common of such hanging filing folders is nothing more than a thin cardboard filing folder into which a report may be placed. Such a folder has a hook on each of its four corners. Once folded, this hanging folder design has two hooks on each side which engage the horizontal rods in the drawer. The report is held in the folder simply by gravity when the hanging folder is suspended by all four hooks. Numerous improved hanging folder solutions have been developed in the prior art which actually secure the sheets of the report in place in the folder. However, these prior art designs suffer from the same shortcomings as the non-hanging binding solutions discussed above. Incorporating more complex designs, they typically include several distinct components and are therefore more expensive to manufacture. They are also more complicated to use. Additionally, like the binding solutions discussed above, use of some of these hanging folder designs results in permanent holes or damage to the sheets of the report. Therefore, these prior art binding solutions for hanging report covers are undesirable.

For the foregoing reasons, there is a need for a binding solution that incorporates many of the desirable features discussed above while keeping the per unit cost of manufacture competitive. Such a solution should adequately protect the report, should adequately secure the sheets of the report in place while still allowing for their removal, should provide support for the report, should be simple to manufacture, should be easy enough for even children to operate, should be a single piece to prevent lost components, and use of the binding solution should not result in damage to the sheets of the report. Additionally, such a binding solution design should be adaptable to use as a hanging file in hanging file drawers of the type known in the art which incorporate horizontal rods running the length of the drawer to allow for the hanging of structurally compatible file folders.

### BRIEF SUMMARY OF THE INVENTION

The present invention provides for an easy to manufacture, one piece design for securing and protecting a report from warping, bending, and crumpling. The one piece design utilizes a flat support panel upon which the report rests. A rigid angular retaining clip protrudes substantially perpendicularly from one edge of the support panel and then angles back towards the flat surface of the support panel. The angular retaining clip deforms slightly to allow the report to be inserted between the retaining clip and the support panel. Once the report is in position, the angular retaining clip compresses the report between itself and the support panel to secure the report in place.

The support panel can be formed with specific dimensions to accommodate and support a report consisting of standard 8.5″ by 11″ pages, legal size pages, or A4 size pages. The single piece design of the present invention may utilize a single piece of polystyrene or any other suitable material known in the art.

One embodiment of the present invention utilizes a file hanger at each longitudinal end of the angular retaining clip. This hanger utilizes a flat hanging surface which rests on the rods of a hanging file drawer and a retention tab which prevents the flat hanging surface from slipping off of the hanging rods.

### BRIEF DESCRIPTION OF THE DRAWINGS

FIG. 1 is a front plan view of one embodiment of a one-piece report cover according to the present invention.

FIG. 2 is a side elevation view of the one-piece report cover shown in FIG. 1.

FIG. 3 is a front plan view of a second embodiment of the one-piece report cover having file hangers.

FIG. 4 is a side elevation view of the embodiment of the one-piece report cover shown in FIG. 3.

FIG. 5 is a rear plan view of the embodiment of the one-piece report cover shown in FIG. 3.

### DESCRIPTION

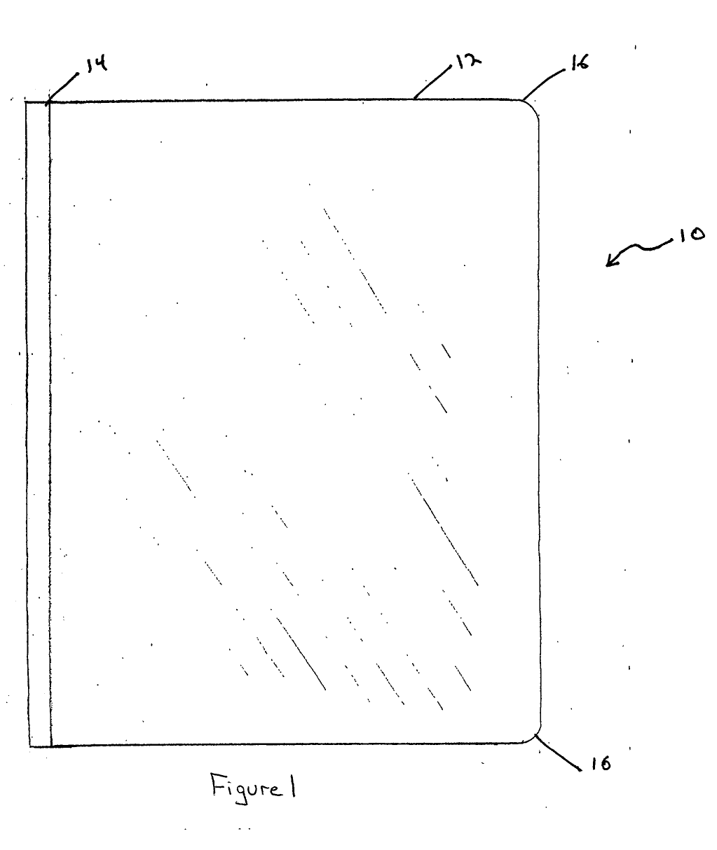

The present invention provides for a report cover which is simple in design and cost-effective to manufacture. FIG. 1 shows one embodiment of the present invention. Report cover 10 utilizes a one-piece design which provides means for securing, supporting, and protecting a report. As earlier defined, a report is any collection of one or more sheets of paper and any associated dividers. As shown in FIG. 1, the single piece design of report cover 10 comprises a flat support panel 12 and an angular retention clip 14.

Flat support panel 12 is a piece of rigid material about 0.030″ thick and covering an area of approximately 8.5″ by 11″ for use with standard letter-sized documents. Other embodiments of the present invention may utilize flat support panels designed and sized for use with other sized documents, including 8.5″ by 14″ legal size paper or A4 size paper. The necessary thickness of flat support panel 12 will vary depending on the rigidity and other structural characteristics of the material used to make report cover 10. A thickness of 0.030″ is preferable for a report cover composed of polystyrene. Of course, the report cover may be made of a number of other materials including, but not limited to, fiberglass or other plastic materials. Flat support panel 12 provides a support surface upon which the individual sheets of a report rest. In this manner, flat support panel 12 supports the report, keeps the report flat, and protects the report from bending, folding, and crumpling. Preferably, the support panel 12 provides sufficient support for the report so that notes may be written on the report using the support panel as a writing surface support. The two corners 16 of flat support panel 12 opposite angular retaining clip 14 are rounded so sharp edges are not presented on these two corners of flat support panel 12. The elimination of sharp edges, while not necessary to the design, is desirable to prevent inadvertent injury to the user.

Angular retaining clip 14 projects substantially perpendicularly from one edge of flat support panel 12. As shown in FIG. 2, angular retaining clip 14 comprises a vertical portion 18 that protrudes substantially perpendicularly above flat support panel 12. Angular retaining clip 14 also comprised a retaining portion 20 that protrudes at an angle from vertical portion 18 such that it descends back toward the flat support panel 12. Retaining portion 20 terminates such that a very small gap separates the edge of retaining portion 20 of angular retaining clip 14 from the surface of flat support panel 12. In the preferred embodiment, vertical portion 18 extends approximately 0.28″ above the flat support panel 12, and retaining portion 20 is approximately 0.375″ in length and forms about a 45° angle with the vertical portion. The material used to make the report cover (e.g., plastic) is resilient so the retaining portion 20 provides a downward force when it is flexed away from flat support panel 12, as it attempts to return to its original shape. In other embodiments, the lengths of vertical portion 18 and retaining portion 20, as well as the angle between the two portions and the size of gap 22 may be varied to accommodate reports of varying thicknesses.

Report cover 10 is used by sliding a report into gap 22 between angular retaining clip 14 and flat support panel 12 of report cover 10 such that the report rests on and is supported by flat support panel 12. In this position, retaining portion 20 of angular retaining clip 14 is positioned against the top surface of the retained report. Alternatively, a separate cover sheet, such as a clear plastic cover, may be inserted between the top surface of the report and retaining portion 20. In either case, retaining portion 20 slightly compresses the report and removably secures the report in place between flat support panel 12 and retaining portion 20 of angular retaining clip 14.

As mentioned above, angular retaining clip 14 and flat support panel 12 are formed as a single piece, preferably polystyrene. The polystyrene piece may be formed and shaped using any of a number of processes known in the prior art including extrusion or molding processes. Because the report cover is manufactured as a single piece, there are not multiple parts of the report cover that need to be manufactured or which may be misplaced by careless users.

The use of a simple one piece design eliminates manufacturing steps which may be required for designs requiring additional retention structure, leading to manufacturing efficiency and potentially a lower per unit cost. The use of a simple retaining design not only eases manufacture but simplifies use. Even young children may use the cover without difficulty. Furthermore, the simple retaining design does not require damage to the sheets of the retained reports by retaining elements designed to go through the surface of said report. Upon removal of the report from report cover 10, the sheets of the report are undamaged and in the same condition as upon their insertion. Additionally, the report cover's support panel 12 provides a semi-rigid back surface for the report. This surface not only helps keep the report in good shape when stored within the cover, it also provides a writing surface for the report. A writing surface for the report is useful should the reader of the report want to take notes on the report when away from a table or desk.

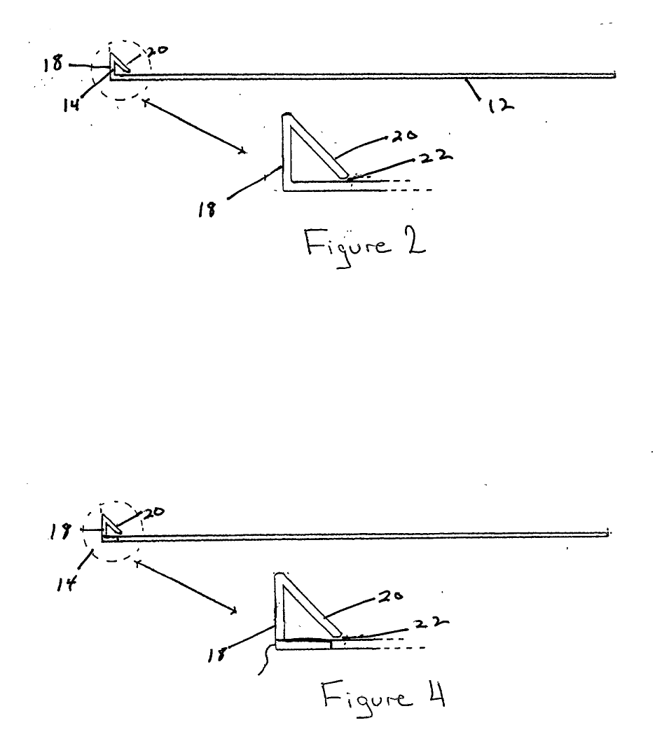

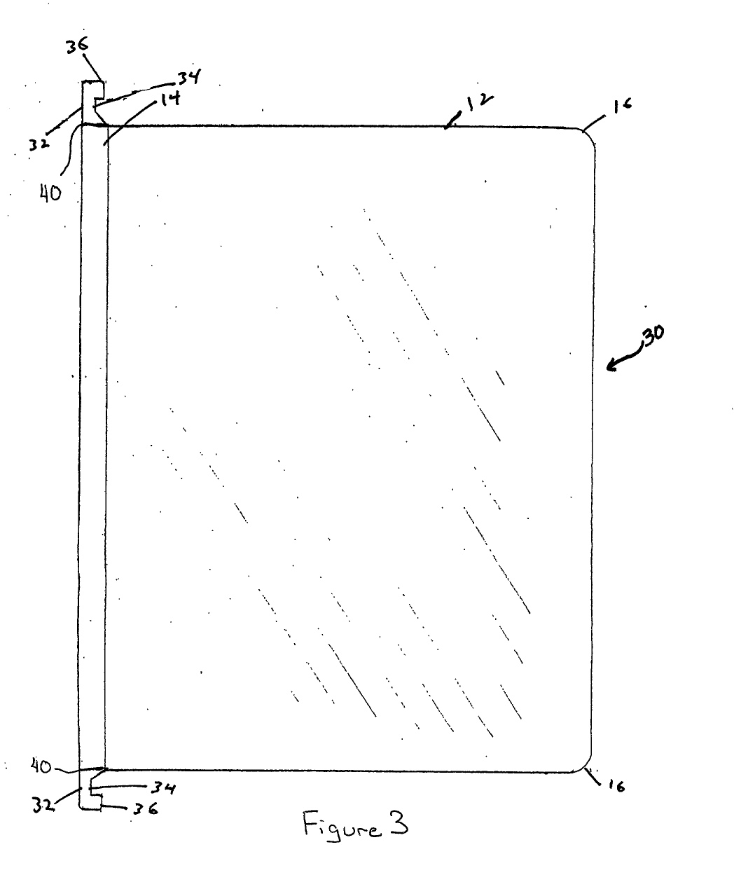

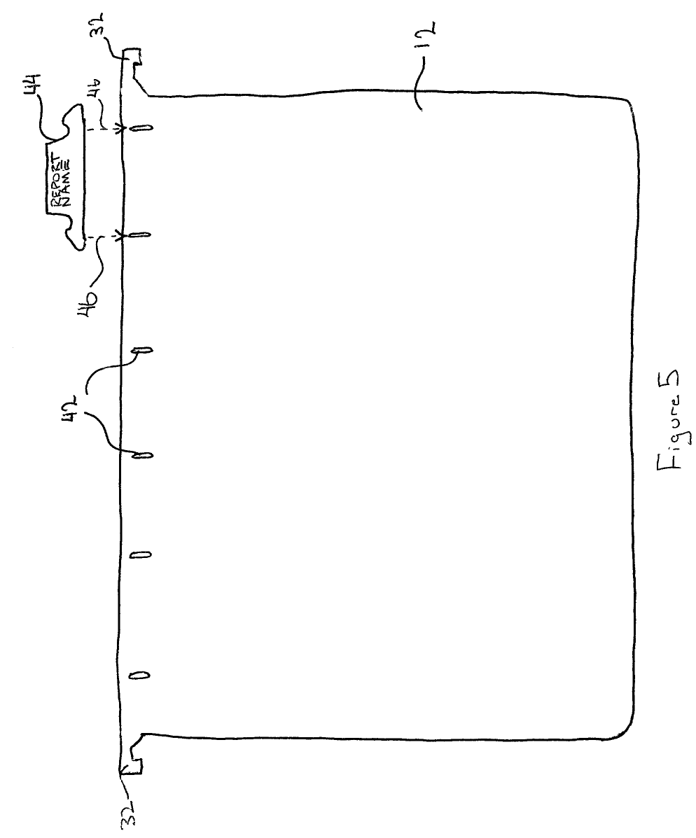

FIG. 3 shows an alternative embodiment, report cover 30, of the present invention which incorporates means for hanging the cover into the report cover design. As shown in FIGS. 3 and 4, report cover 30 is similar to report cover 10. The same reference numbers have been used to refer to the structures of this embodiment as are used with the corresponding structures of report cover 10. Like report cover 10, report cover 30 utilizes flat support panel 12 and angular retaining clip 14 with vertical portion 16 and retaining portion 18. The preceding discussion of these design elements in regards to report cover 10 is also applicable to report cover 30, and the method of retaining the report is the same.

In addition to those elements which it has in common with report cover 10, report cover 30 utilizes two file hangers 32 which extend in opposite directions outward from each longitudinal end 40 of angular retaining clip 14 and along the same plane as the surface of flat support panel 12. As can be seen from FIG. 3, each file hanger 32 comprises a hanging surface 34 adjacent to flat support panel 12 and a retention tab 36 adjacent to hanging surface 34. The shape of hanging surface 34 and retention tab 36 is similar to those of standard file hangers used for hanging file folders. Using this alternative embodiment of the invention, reports contained within report cover 30 may be easily organized and positioned within a hanging file without the need for purchasing a separate hanging file folder. As previously described, drawers in filing cabinets or desks may be designed with two horizontal rods for suspending file folders with filing hanger. The current embodiment of the present invention is positioned in such a drawer by hanging report cover 30 such that hanging surfaces 34 rest on these rods. Retention tabs 36 prevent report cover 30 from disengaging these rods and falling.

In addition the report cover 30 may includes slots 42 for receiving standard hanging folder tabs used to identify the hanging folder when placed in a file drawer. This embodiment of the invention is shown in FIG. 5, which shows the back side of support surface 12 with slots 42 along the top of the support surface for receiving a tab 44, as indicated by dotted lines and arrows 46.

Like report cover 10, report cover 30 is a unitary design preferably constructed of polystyrene using known manufacturing processes such as extrusion or molding. Since report cover 30 incorporates the basic design of report cover 10, the benefits of report cover 10 discussed above are retained in the design of report cover 30. Report cover 30 has the added benefit of easy and convenient storage and organization in a standard hanging file cabinet. Compared to other hanging file folders available, the design of the present invention allows a report to be firmly secured in place without the use of costly complex designs and while retaining a relatively low cost per unit.

Although the present invention has been described in considerable detail with reference to certain exemplary versions thereof, other versions are possible, such as embodiments utilizing different material of manufacture. Therefore, the spirit and scope of the appended claims should not be limited to the description of the exemplary versions contained herein, and the claims should be given the broadest possible interpretation to protect the novel features of the present invention.

What is claimed is:

1. A report cover for binding a report of at least one page comprising:
a. a support panel providing a rigid back for the report and having a first edge and a second edge; and
b. an angular retaining clip protruding substantially perpendicularly from the first edge of the support panel and angling back towards the support panel wherein the support panel and the angular retaining clip are integrally formed as a single piece.

2. The report cover of claim 1 wherein the first edge of the support panel has a length in the range of about 8 inches to about 9 inches and the second edge has a length in the range of about 10.5 inches to about 12 inches.

3. The report cover of claim 1 wherein the first edge of the support panel has a length in the range of about 8 inches to about 9 inches and the second edge has a range of about 13.5 inches to about 15 inches.

4. The report cover of claim 1 wherein the support panel and the angular retaining clip are produced of polystyrene.

5. The report cover of claim 1 wherein the angular retaining clip further comprises two longitudinal ends and each longitudinal end of the angular retaining clip terminates in a file hanger, the file hanger having a hanging surface extending from the angular retaining clip and having a retention tab projecting from the flat hanging surface.

6. The report cover of claim 1 wherein the angular retaining clip further comprises two longitudinal ends and each longitudinal end of the angular retaining clip terminates in means for suspending the report cover in a filing cabinet.

7. A report cover for binding a report of at least one page, comprising:
a. a support panel providing a rigid back for the report and having a first edge and a second edge, and
b. means for retaining the report against the support panel wherein the support panel and the means for retaining the report are integrally formed as a single piece.

8. The report cover of claim 7 wherein the first edge of the support panel has a length in the range of about 8 inches to about 9 inches and the second edge has a length in the range of about 10.5 inches to about 12 inches.

9. The report cover of claim 7 wherein the first edge of the support panel has a length in the range of about 8 inches to about 9 inches and the second edge has length in the range of about 13.5 inches to about 15 inches.

10. The report cover of claim 7 wherein the support panel and the means for retaining the report are produced of polystyrene.

11. The report cover of claim 7 further comprising means for suspending the report cover in a filing cabinet wherein the means for suspending the report cover, the means for retaining the report, and the support panel are integrally formed as a single piece.

12. A report cover for binding a report of at least one page, each page having an edge, the report cover comprising:
a. a support panel, the support panel having a first edge and a second edge; and
b. an angular retaining clip protruding substantially perpendicularly from the first edge of the support panel and angling back towards the support panel wherein the edge of the at least one page of the report is frictionally retained between the angular retaining clip and the support panel, and the support panel and the angular retaining clip are integrally formed as a single piece.

13. The report cover of claim 12 wherein the first edge of the support panel has a length in the range of about 8 inches to about 9 inches and the second edge has a length in the range of about 10.5 inches to about 12 inches.

14. The report cover of claim 12 wherein the short edge of the support panel has a length in the range of about 8 inches to about 9 inches and the long edge has a length in the range of about 13.5 inches to about 15 inches.

15. The report cover of claim 12 wherein the support panel and the angular retaining clip are produced of polystyrene.

16. The report cover of claim 12 wherein the angular retaining clip further comprises two longitudinal ends and each longitudinal end of the angular retaining clip terminates in a file hanger, the file hanger having a flat hanging surface extending from the angular retaining clip and having a retention tab projecting perpendicularly from the flat hanging surface.

17. The report cover of claim 12 wherein the angular retaining clip further comprises two longitudinal ends and each longitudinal end of the angular retaining clip terminates in means for suspending the report cover in a filing cabinet.
